(19) United States
(12) Patent Application Publication
(10) Pub. No.: US 2025/0002319 A1
(43) Pub. Date: Jan. 2, 2025

(54) DRINKING-WATER COOLING SYSTEM FOR COOLING, STORING AND FILTERING DRINKING WATER

(71) Applicant: Aquis Systems AG, Rebstein (CH)

(72) Inventor: Kai HUCK, Walzenhausen (CH)

(21) Appl. No.: 18/742,235

(22) Filed: Jun. 13, 2024

(30) Foreign Application Priority Data
Jun. 27, 2023 (EP) 23181808.9

(51) Int. Cl. B67D 1/00; B67D 1/08

(52) U.S. Cl. CPC B67D 1/0014; B67D 1/0859; B67D 2210/0001; B67D 2210/00104

(57) ABSTRACT

A drinking-water cooling system for cooling, storing and filtering drinking water, wherein at least one drinking-water reservoir for storing the drinking water and at least one cooling unit for cooling the drinking water stored in the drinking-water reservoir and at least one filter unit for filtering and/or purifying the drinking water to be cooled and stored, said filter unit comprising at least filter water, are provided, wherein the drinking-water reservoir comprises at least one inflow opening for filling and/or for the inflow of the drinking water to be cooled and stored and one outflow opening for the removal and/or outflow of the cooled and stored drinking water, is proposed, wherein the design complexity and economic expenditure and/or the energy consumption is reduced as much as possible in comparison with the prior art and/or convenience is improved for the user. This is achieved in one example in that a fixing unit comprises at least one first coupling element of a coupling unit for releasably fixably coupling the filter unit, so that the filter unit is in the form of an exchangeable filter unit.

### CROSS-REFERENCE TO RELATED APPLICATION

This application claims the benefit of European Application No. 23 181 808.9, filed Jun. 27, 2023, the contents of which are hereby incorporated by reference in its entirety.

### BRIEF DESCRIPTION OF THE DRAWINGS

FIG. 1 shows a schematic section through a cooled construction unit having a filter and a water tank, in one example.

FIG. 2 shows a schematic view of an installed and removed exchangeable filter unit having a screw filter head or bayonet filter head, in one example.

### DETAILED DESCRIPTION

The present disclosure generally relates to a drinking-water cooling system for cooling, storing and filtering drinking water.

Water-dispensing devices are typically connected to the public water supply network. They are often in the form of so-called water dispensers and are installed in public buildings, hotels, shopping centers and hospitals. Alternatively, corresponding water-dispensing devices can be designed as under-counter or under-sink devices that can dispense processed water via sink faucets.

For all variants, there is the difficulty of dispensing water of the purest quality possible to the consumer. First, the concentration of impurities, such as microplastics, chlorine and off-odors, etc., in the water to be dispensed is determined by the quality of the water provided by the water supply facility. In addition, there is the risk that, in devices with a water-heating apparatus, limescale will reduce the service life of the unit.

To guarantee long-term protection and to remove harmful substances in the drinking water, water filters are installed directly in the water circuit.

Water-dispensing devices for dispensing cooled carbonated drinking water and/or cooled sparkling water require a connected cooling apparatus. The cooling apparatus can be implemented with an active cooling means, such as a compressor or a Peltier element assembly.

A widespread embodiment of active sources of coldness is the cooling assembly consisting of an electrically operated compressor, an associated heat exchanger and a cooling spiral assembly which receives flow from the compressor. The cooling spiral assembly is in thermal contact with the fluid to be cooled, which is in the water tank. For improvement of the cooling efficiency, the heat exchanger is directly connected to a fan so that the coolant flowing through the heat exchanger is cooled. For improvement of the cooling capacity, removing the arising heat flow from the water-dispensing device into the outer environment by means of air circulation or an air duct is indispensable.

Devices that are used in buildings are generally installed in locations that are at room temperature. When the device is inactive for a prolonged period, the device and the media contained therein also warm up to room temperature. In installations in which the device is installed in a cabinet, for example, the ambient temperature in the surroundings of the device can rise considerably above room temperature, in the absence of sufficient ventilation/air cooling. In order to also ensure the low target temperature of the cold water during standby operation or idle operation, the cooling system must be periodically activated so that the heat losses that occur are compensated by recooling. As a result, the cooling circuit regularly produces corresponding waste heat, which, if there is insufficient ventilation/cooling, leads to warming of the components installed within the housing, such as the water guide, the fresh water tank, the filter, etc., and to warming of the media.

The stored water in the water filter is often at or even above room temperature. When cooled water is subsequently tapped, the water in the filter store, which water has warmed to the ambient temperature, flows into the cooling tank. The warmed water volume within the cooling tank has a negative effect on the cooling process, since the cooling time until a water temperature that is set low is reached increases considerably, leading to increased energy consumption and a longer waiting time.

It is an object of the present disclosure to propose a drinking-water cooling system for cooling, storing and filtering drinking water, wherein the design complexity and economic expenditure and/or the energy consumption is reduced as much as possible in comparison with the prior art and/or convenience is improved for the user.

This object is, proceeding from a drinking-water cooling system of the type mentioned at the beginning, by the features of claim 1. Advantageous embodiments and developments of the present disclosure are made possible by the measures mentioned in the dependent claims.

Accordingly, a drinking-water cooling system according to one example for cooling, storing and filtering drinking water is characterized in that the fixing unit comprises at least one first coupling element of a coupling unit for releasably fixably coupling the filter unit, wherein the filter unit has at least one second coupling element of the coupling unit and wherein, when the fixing unit is in the fixed state, the first coupling element and the second coupling element are in operative connection with one another, so that the filter unit is in the form of an exchangeable filter unit.

By means of the coupling according to one example or the exchangeable filter unit, an advantageous exchange of the filter unit can be carried out, in particular without tools. This improves the convenience and economy for the user of the system.

Advantageously, a filter end portion of the exchangeable filter unit and/or an exchangeable housing of the exchangeable filter unit comprises at least the second coupling element and at least one filter inflow opening for the inflow of the drinking water to be filtered and/or purified and one filter outflow opening for the removal and/or outflow of the filtered and/or purified drinking water. As a result, the filter unit or the exchangeable filter unit can be advantageously exchanged or replaced in a simple way.

In one example, the fixing unit comprises at least one fixing inflow opening for the inflow of the drinking water to be filtered and/or purified and one fixing outflow opening for the removal and/or outflow of the filtered and/or purified drinking water. Thus, the filter unit or the exchangeable filter unit can advantageously be fixed and be supplied and drained, i.e. realize the inflow and outflow of the drinking water, at the so-called “head” or at only one end.

Optionally, the coupling unit is in the form of a locking and/or clamping unit. The coupling unit is advantageously in the form of a screw closure having a screw thread, wherein the first coupling element comprises a first thread element of the screw closure and the second coupling element comprises a second thread element of the screw closure. In this way, a secure and lasting and easily releasable connection/fixing can be implemented.

Alternatively, the coupling unit can be in the form of a bayonet closure having a bayonet connection, wherein the first coupling element is in the form of a first bayonet element of the bayonet closure and the second coupling element is in the form of a second bayonet element of the bayonet closure. In this way too, a secure and lasting and easily releasable connection/fixing can be implemented.

The filter unit advantageously has at least one filter longitudinal axis, wherein a filter length is greater than a filter width and/or a filter diameter, and the drinking-water reservoir and/or the cooling unit has at least one reservoir longitudinal axis, wherein a reservoir length is greater than a reservoir width and/or a filter diameter. In this way, an advantageous geometry for the cooling of the filter can be realized.

For example, the filter longitudinal axis is substantially parallel to the reservoir longitudinal axis. In this way, an advantageous orientation of the two components is achieved.

In one example, the filter unit has at least one filter housing and also the drinking-water reservoir has at least one reservoir housing and/or the cooling unit has at least one cooling housing. The filter housing advantageously at least partly comprises the reservoir housing and/or the cooling housing.

In one example, the filter housing has at least one filter housing surface and/or the reservoir housing has at least one reservoir housing surface and/or the cooling housing has at least one cooling housing surface. Thus, the filter housing surface can advantageously at least partly comprise the reservoir housing surface and/or cooling housing surface. As a result, good heat transfer or cooling is advantageously possible. Also, the design complexity is reduced.

The fixing unit advantageously has at least one connection unit for releasably adjustably connecting the fixing unit to the filter housing. Thus, the fixing unit for fixing the filter unit can also be releasably connectably arranged on the filter housing or on the drinking-water cooling system. The installation and removal or replacement of the filter unit or exchangeable filter unit can is thereby improved, i.e. can be easily implemented and securely or precisely/exactly positioned.

In one example, the connection unit is in the form of an exchangeable connection unit or in the form of a pivoting unit for the pivoting of the connection unit and/or of the fixing unit about a pivot axis. The fixing unit can thereby advantageously be pivoted about the pivot axis for the replacement of a filter unit.

Alternatively, the connection unit and/or exchangeable connection unit can be in the form of a screw connection unit or bayonet connection unit having a screw device or bayonet device.

At least one cold-bridge element is advantageously arranged between the filter unit and/or the filter housing and the drinking-water reservoir and/or the reservoir housing and/or the cooling unit and/or the cooling housing, so that the filter unit and/or the filter housing can be cooled by the cooling unit and/or by the cooling housing and/or heat transfer between the filter unit and/or the filter housing and the cooling unit and/or the cooling housing can occur. The cooling can thereby be improved further.

For example, the cold-bridge element is in the form of a gap filled with gas, in particular with air, and/or the cold-bridge element comprises at least one thermally conductive material, in particular a thermally conductive paste or a metal. This improves the heat transfer or cooling considerably.

At least one thermal insulation unit for thermally insulating at least the cooling unit and/or the drinking-water reservoir is advantageously provided. In this way, heat losses can be reduced or the cooling can be improved further.

For example, the insulation unit comprises at least one insulation housing and/or insulation sheath element, wherein at least the filter unit and/or the filter housing and the drinking-water reservoir and/or the reservoir housing and/or the cooling unit and/or the cooling housing are arranged at least partly within and/or in an interior of the insulation unit and/or of the insulation housing and/or of the insulation sheath element. A particularly compact or space-saving implementation can thereby be realized.

In one example, the filter unit is arranged upstream of the drinking-water reservoir and/or the cooling unit in the flow direction of the drinking water. In this way, the drinking water is advantageously already pre-cooled in the filter and is subsequently fed to the reservoir or tank and advantageously further cooled there.

In general, according to one example the liquid in the reservoir or cooling tank can be energy-efficiently and quickly cooled to low temperature. For example, the stored volume contained in the store of the water filter can be cooled, so that said volume advantageously at least has a temperature below the existing ambient temperature.

Advantageous embodiments of drinking-water dispensers/units or sanitary fittings are designed such that they have, for example, the water filter integrated within the housing. By means of an advantageous mechanism, for example in the form of a flap or door, etc., the access for the regular replacement of the filter can be provided. This improves the ease of maintenance or ease of repair of the system.

As a possible embodiment, the filter is advantageously embedded in the module of the cooling tank/cooling reservoir by virtue of the fact that, for example, insulation—in a specific embodiment, unitary insulation—surrounds the two components filter and cooling tank or reservoir.

The thermal contact between the optionally metal outer wall of the cooling tank and the chamber of the water filter can be provided, for example, by means of a coupling component having high thermal conductivity, preferably aluminum. If the filter and the cooling tank/reservoir are advantageously close together, the heat transfer can be accomplished, for example, by means of convection across the small air gap which is present.

An advantageous temperature difference between the outer wall of the cooling tank and the filter housing causes a withdrawal of thermal energy from the filter medium, resulting in cooling of the water stored in the filter. Thus, the tap water flowing into the filter can be stabilized at a temperature level below the ambient temperature. As a result of this pre-cooling, the subsequent cooling process of the cold water in the cooling tank or reservoir is improved, and thus the cooling time is significantly reduced.

Examples are shown in the drawing and are explained in more detail below with reference to the figures.

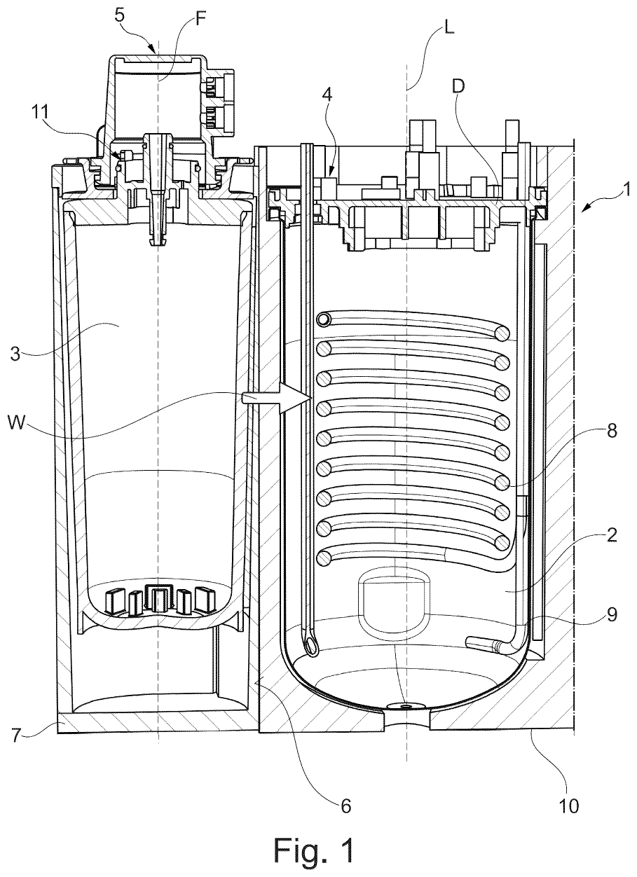

FIG. 1 shows a tank system 1 having a tank 2. The tank 2 is used, first of all, to cool water, which is introduced on the cover side by means of the filling apparatus 4 via the cover D in the upper region of the tank 2. The filling apparatus 4 comprises a tube, which is shifted toward the wall of the tank 2 radially with respect to its longitudinal axis L. This tube of the filling apparatus 4 comprises a filling inlet, which, for example, leads into a deflecting apparatus. This deflecting apparatus extends arcuately along the wall of the tank 2 and improves the inflow of the water in an advantageous way.

The volume V of the tank 2 forms a hollow cylinder, in which a cooling coil 8 is arranged. In addition, a withdrawal tube 9 is provided, which, for example, is in the form of a lance and extends from the cover D through the interior into the lower region of the tank 2. Thus, the tank 2 and the tank system 1 can profit from a thermal stratification when the liquid to be cooled is continuously cooled by means of the coil 8 and water cooled in the process principally settles, however, in the lower region, so that cooled water can also accordingly be withdrawn by means of the lance 9.

The cooled water is led further by means of the withdrawal tube 9. Thus, in the flow direction of the (cooled) water, carbon dioxide is advantageously subsequently fed into the water in order to carbonate the water. The withdrawal tube 9 and also the filling apparatus 4 can be made of a plastic which is suitable for drinking water and which is also thermally conductive in order to assist the cooling.

A filter 3 is advantageously provided/arranged upstream of the tank 2 in the flow direction of the water. The filter has an inlet 5, in which water flows in from the water line or the drinking-water network or the like. The filter 3 has a filter axis F, which is advantageously arranged/oriented parallel to the axis L of the tank 2.

Also, the filter 3 has a housing 7 and the tank 2 has a housing 10, which are in contact with one another at a contact surface, i.e. these two housings advantageously touch one another. Thus, heat or thermal energy W can be transported from the filter 3 to the tank 2 (see arrow W). This means that the filter 3 is cooled, specifically by means of the cooling coil 8 of the tank 2. In this way, a temperature gradient is advantageously generated, which allows the temperature to fall or drop from the inlet 5 of the filter 3, over a line (not shown in more detail) to the tank 2, into the interior, in particular to the lower region of the tank 2.

Thus, in this advantageous embodiment the filter is advantageously cooled by means of the cooling coil 8 of the tank 2 indirectly across the contact surface 6 or the housings 7, 10. For example, a thermally conductive material can advantageously be arranged or be present between the tank 2 or the wall/housing 10 thereof and the filter 3 or the wall/housing 7 thereof.

Thus, the water filter or filter 3 can be cooled by an advantageous so-called “cold bridge” between the cooling tank 2 and the water filter 3. The water filter 3 is advantageously arranged in close proximity to the cooling tank 2. The water filter is, for example, thermally insulated, e.g. by embedment of the filter 3 and the cooling module or the tank 2 or the housing 10 thereof in unitary or mutual, sheathing/surrounding thermal insulation.

As an advantageous so-called “cold bridge”, for example an air gap and/or insulation and/or in a special embodiment can be realized or at least partly filled with an advantageous thermally conductive material, e.g. metal. Thus, advantageous heat transfer from the filter 3 to the cooled outer wall or housing 10 of the cooling tank 2 can be realized by means of convection or heat conduction.

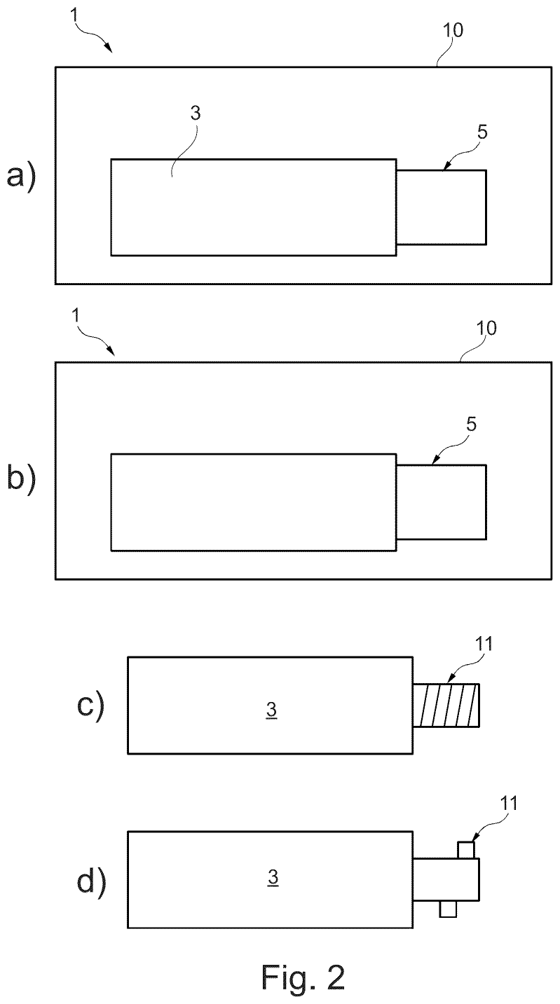

FIG. 2 shows schematic views of installed and removed exchangeable filter units 3, with a screw filter head on the one hand and with a bayonet filter head on the other hand. In FIG. 2a), the filter unit 3 or exchangeable filter unit 3 is rigidly fixed in the tank system 1 at the inlet 5. The inlet 5 is in the form of a fixing unit 5 or filter receptacle 5 and allows a filter unit 3 at the end of its functional capability or a used-up filter unit 3 to be advantageously replaced by/exchanged for a new or unused filter unit 3.

FIG. 2b) shows the tank system 1 without a filter unit 3 or exchangeable filter unit 3. It is made clear here that the inlet 5 or the fixing unit 5 still remains in the system, but the filter unit 3 or exchangeable filter unit 3 is no longer installed/fixed in the tank system 1.

FIGS. 2c) and 2d) show two different coupling mechanisms or filter heads 11, i.e. a screw head on the one hand and a bayonet head on the other hand, which are brought into operative connection with a corresponding inlet 5 or fixing unit 5 for fixation (cf. FIG. 2a)). Alternatively, a locking or clamping head can also be provided. Thus, the filter unit 3 or exchangeable filter unit 3 can advantageously be removed from the filter-head holder 5 or the inlet 5 and securely and precisely inserted again/fixed again. At the same, the cooling is not impaired or limited by the replacement or the exchange of the filter unit 3 or exchangeable filter unit 3. Furthermore, the newly inserted filter unit 3 or exchangeable filter unit 3 is held exactly in position, so that the heat transfer can be advantageously realized.

Although the present invention has been described with reference to preferred embodiments, workers skilled in the art will recognize that changes may be made in form and detail without departing from the spirit and scope of the invention.

1. A drinking-water cooling system for cooling, storing and filtering drinking water, the drinking-water cooling system comprising:
at least one drinking-water reservoir for storing the drinking water;
at least one cooling unit for cooling the drinking water stored in the at least one drinking-water reservoir;
at least one filter unit for filtering and/or purifying the drinking water to be cooled and stored, at least one filter unit comprising at least filter water; and
at least one fixing unit for fixing/holding the at least one filter unit, wherein
the at least one drinking-water reservoir comprises at least one inflow opening for filling and/or for the inflow of the drinking water to be cooled and stored and one outflow opening for removal and/or outflow of the cooled and stored drinking water,
the at least one cooling unit is in the form of a filter cooling unit for at least partially cooling the at least one filter unit and/or the filter water,
the at least one fixing unit comprises at least one first coupling element of a coupling unit for releasably fixably coupling the at least one filter unit, wherein
the at least one filter unit has at least one second coupling element of the coupling unit, and
when the at least one fixing unit is in a fixed state, the at least one first coupling element and the at least one second coupling element are in operative connection with one another, so that the at least one filter unit is in the form of an exchangeable filter unit.

2. The drinking-water cooling system according to claim 1, wherein a filter end portion of the exchangeable filter unit and/or an exchangeable housing of the exchangeable filter unit comprises at least the at least one second coupling element and at least one filter inflow opening for the inflow of the drinking water to be filtered and/or purified and one filter outflow opening for the removal and/or outflow of the filtered and/or purified drinking water.

3. The drinking-water cooling system according to claim 1, wherein the at least one fixing unit comprises at least one fixing inflow opening for the inflow of the drinking water to be filtered and/or purified and one fixing outflow opening for the removal and/or outflow of the filtered and/or purified drinking water.

4. The drinking-water cooling system according to claim 1, wherein the coupling unit is in the form of a screw closure having a screw thread, wherein the at least one first coupling element comprises a first thread element of the screw closure and the at least one second coupling element comprises a second thread element of the screw closure.

5. The drinking-water cooling system according to claim 1, wherein the coupling unit is in the form of a bayonet closure having a bayonet connection, wherein the at least one first coupling element is in the form of a first bayonet element of the bayonet closure and the at least one second coupling element is in the form of a second bayonet element of the bayonet closure.

6. The drinking-water cooling system according to claim 1, wherein the at least one filter unit has at least one filter housing and/or the at least one drinking-water reservoir has at least one reservoir housing and/or the cooling unit has at least one cooling housing and/or in that the at least one filter housing has at least one filter housing surface and/or the at least one reservoir housing has at least one reservoir housing surface and/or the at least one cooling housing has at least one cooling housing surface, wherein the at least one filter housing surface at least partly comprises the at least one reservoir housing surface and/or the at least one cooling housing surface.

7. The drinking-water cooling system according to claim 6, wherein the at least one fixing unit has at least one connection unit for releasably adjustably connecting the at least one fixing unit to the at least one filter housing.

8. The drinking-water cooling system according to claim 7, wherein the at least one connection unit is in the form of an exchangeable connection unit or in the form of a pivoting unit for the pivoting of the at least one connection unit and/or of the at least one fixing unit about a pivot axis.

9. The drinking-water cooling system according to claim 7, wherein the at least one connection unit and/or exchangeable connection unit is in the form of a screw connection unit or bayonet connection unit having a screw device or bayonet device.

10. The drinking-water cooling system according to claim 1, wherein at least one cold-bridge element is arranged between the at least one filter unit and/or the at least one filter housing and the at least one drinking-water reservoir and/or the at least one reservoir housing and/or the at least one cooling unit and/or the at least one cooling housing, so that the at least one filter unit and/or the at least one filter housing can be cooled by the at least one cooling unit and/or by the at least one cooling housing and/or heat transfer between the at least one filter unit and/or the at least one filter housing and the at least one cooling unit and/or the at least one cooling housing can occur, wherein the at least one cold-bridge element is in the form of a gap filled with air, and/or the cold-bridge element comprises at least one thermally conductive material, the at least one thermally conductive material comprises one or more of a thermally conductive paste or a metal.

11. The drinking-water cooling system according to claim 1, and further comprising at least one thermal insulation unit for thermally insulating at least the at least one cooling unit and/or the at least one drinking-water reservoir.

12. The drinking-water cooling system according to claim 1, wherein the at least one filter unit is arranged upstream of the drinking-water reservoir and/or the cooling unit in a flow direction of the drinking water.

13. A sanitary fitting unit for dispensing at least double-processed drinking water in the form of filtered/purified and cooled drinking water, comprising at least one drinking-water cooling system comprising:
at least one drinking-water reservoir for storing the drinking water;
at least one cooling unit for cooling the drinking water stored in the drinking-water reservoir;
at least one filter unit for filtering and/or purifying the drinking water to be cooled and stored, at least one filter unit comprising at least filter water; and
at least one fixing unit for fixing/holding the at least one filter unit, wherein
the at least one drinking-water reservoir comprises at least one inflow opening for filling and/or for the inflow of the drinking water to be cooled and stored and one outflow opening for the removal and/or outflow of the cooled and stored drinking water,
the at least one cooling unit is in the form of a filter cooling unit for at least partially cooling the at least one filter unit and/or the filter water,
the at least one fixing unit comprises at least one first coupling element of a coupling unit for releasably fixably coupling the at least one filter unit,
the at least one filter unit has at least one second coupling element of the coupling unit, and
when the at least one fixing unit is in a fixed state, the at least one first coupling element and the at least one second coupling element are in operative connection with one another, so that the at least one filter unit is in the form of an exchangeable filter unit.

14. The sanitary fitting unit of claim 13, wherein the drinking water comprises carbonated drinking water.
